(19) United States
(12) Patent Application Publication
(10) Pub. No.: US 2004/0254776 A1
(43) Pub. Date: Dec. 16, 2004

(54) Method for calculating delay time of semiconductor integrated circuit and delay time calculation system

(75) Inventor: Katsumi Andou, Kasugai (JP)

Correspondence Address: ARENT FOX KINTNER PLOTKIN & KAHN, 1050 CONNECTICUT AVENUE, N.W., SUITE 400, WASHINGTON, DC, 20036, US

(73) Assignee: FUJITSU LIMITED

(21) Appl. No.: 10/887,099

(22) Filed: Jul. 9, 2004

Related U.S. Application Data
(63) Continuation of application No. PCT/JP02/00113, filed on Jan. 11, 2002.

(51) Int. Cl. G06F 17/50

(52) U.S. Cl. 703/19

(57) ABSTRACT

A delay time calculation method and a delay time calculation system for a semiconductor integrated circuit that enables timing testing to be efficiently performed. The propagation delay time for a signal path taking into consideration variations in the chip is calculated based on a corrected variation coefficient. The corrected value of the variation coefficient is calculated based on a function that approximates the propagation delay time caused by variations in the chip as a propagation delay time affected by the actual variations in the chip in accordance with the number of cell stages in the signal path. Accordingly, the propagation delay time is calculated to have an appropriate occurrence probability corresponding to a 3σ range in the probability density distribution.

### CROSS-REFERENCE TO RELATED APPLICATIONS

This application is a continuation of, and claims priority from International PCT Application No. PCT/JP02/00113, filed on Jan. 11, 2002, the contents being incorporated herein in entirety by reference.

### BACKGROUND OF THE INVENTION

The present invention relates to a delay time calculation method and a delay time calculation system for a semiconductor integrated circuit.

The speed and frequency of recent semiconductor integrated circuits (LSI) have become higher. This has significant reduced timing margins for signals. Thus, when designing an LSI, a timing check (a timing verification) must be accurately carried out taking into consideration signal propagation delay time.

When designing a semiconductor integrated circuit (LSI), logic simulation and a timing check are carried out in view of the signal propagation delay within the LSI. It is generally known that the signal propagation delay depends mainly on three factors, the process characteristics, the power supply voltage, and the junction temperature involved in the change of ambient temperature.

The logic simulation is normally carried out, in consideration of each of the above mentioned factors, under three types of conditions, a condition in which the delay time is maximum (hereinafter referred to as the MAX condition), a condition in which the delay time is typical (hereinafter referred to as the TYP condition), and a condition in which the delay time is minimum (hereinafter referred to as the MIN condition).

The MAX condition is a condition in which the operation speed of a transistor is the slowest, the power supply voltage is the lowest, and the junction temperature is the highest. The TYP condition is a condition in which the operation speed of the transistor and the power supply voltage have typical values, and the junction temperature is a predetermined temperature (e.g., 25° C.). The MIN condition is a condition in which the operation speed of the transistor is the fastest, the power supply voltage is the highest, and the junction temperature is the lowest.

FIG. 7 is a diagram showing the propagation delay time under each condition.

In the drawing, a data path is the signal path for an interiorly retrieved input signal (data signal), and a clock path is the signal path for a timing signal (clock signal) for comparison with the timing for interiorly retrieving the data signal.

If, for example, the delay times of the clock path and the data path under the TYP condition are both normalized as 1.0, the delay times for the clock path and the data path under the MAX condition both become 1.5, and the delay times of the clock path and the data path under the MIN condition both become 0.5. In other words, the propagation delay time of the clock path and the data path differs between the MAX condition, the TYP condition, and the MIN condition and the change in the delay time in each condition is shown ideally with a linear line.

Factors that influence the change of the propagation delay times of the clock path and the data path are also present in an LSI chip.

Examples of the factors are listed below.

(1) process characteristic variations due to variations in transistor characteristic, wiring resistance, and contact resistance;

(2) power supply voltage variation due to power supply voltage drop within the chip;

(3) temperature variation within the chip due to non-uniform device arrays and operating frequencies within the chip.

The above-mentioned factors (1) to (3) are referred to as in-chip variations.

FIG. 8 is a diagram showing a device propagation delay time taking into consideration the in-chip variations.

Arrow (a) indicates that the delay time of the clock path may vary between 1.2 and 1.5 when the delay time of the data path is 1.5 under the MAX condition. That is, the arrow (a) indicates a condition in which the delay of the clock path is minimum under the MAX condition. In LSI designing, by performing the timing check under the condition indicated by the arrow (a), the set-up time check may be carried out under the MAX condition.

Arrow (b) indicates that the delay time of the data path may vary between 1.2 and 1.5 when the delay time of the clock path is 1.5 under the MAX condition. That is, the arrow (b) indicates a condition in which the delay of the data path is minimum under the MAX condition. In LSI designing, by performing the timing check under the condition indicated by the arrow (b), the hold time check may be carried out under the MAX condition.

Arrow (c) indicates that the delay time of the data path may vary between 0.5° and 0.7 when the delay time of the clock path is 0.5 under the MIN condition. That is, the arrow (c) indicates a condition in which the delay of the data path is maximum under the MIN condition. In LSI designing, by performing the timing check under the condition indicated by the arrow (c), the set-up time check may be carried out under the MIN condition.

Arrow (d) indicates that the delay time of the clock path may vary between 0.5 and 0.7 when the delay time of the data path is 0.5 under the MIN condition. That is, the arrow (d) indicates a condition in which the delay of the clock path is maximum under the MIN condition. In LSI design, by performing the timing check under the condition indicated by the arrow (d), the hold time check may be carried out under the MIN condition.

Therefore, in view of the in-chip variations mentioned above, the device propagation delay time may vary within a range defined by the MAX condition—(a)-(c)—the MIN condition—(d)-(b).

FIG. 9 is a diagram showing wiring propagation delay time taking into consideration the in-chip variations. In a manner similar to the above mentioned device propagation delay time (refer to FIG. 8), the wiring propagation delay time may vary within a range defined by the MAX condition—(a)-(c)—the MIN condition—(d)-(b).

One example of performing the hold time check under the MIN condition in a flip-flop will now be explained.

FIG. 10 is a detailed circuit diagram for performing the timing check. A circuit 30 includes buffers (hereinafter referred to as BUF) 31 and 32a to 32j, and D flip-flops (hereinafter referred to as DFF) 33a and 33b.

A clock signal is input to an input terminal CK of the BUF 31, and an output signal of the BUF 31 is input to the BUF 32a and the BUF 32f. The BUFs 32a to 32e are connected in series and an output signal of the BUF 32e is input to a clock input terminal C of the DFF 33b. The BUFs 32f to 32j are connected in series and an output signal of the BUF 32j is input to a clock input terminal C of the DFF 33a. A signal output from an output terminal Q of the DFF 33a is input to a data input terminal D of the DFF 33b.

In the circuit 30, the signal path from the input terminal CK to the clock input terminal C of the DFF 33b is the clock path, and the signal path from the input terminal CK to the data input terminal D of the DFF 33b is the data path.

In the circuit 30, the DFF 33b outputs the signal (data signal), which is input via the data path to the data input terminal D, to an internal circuit in response to the clock signal, which is input via the clock path to the clock input terminal C.

When performing the hold time check under the MIN condition in the DFF 33b using the circuit 30, the propagation delay time in the data path and the clock path are calculated under the condition indicated by the arrow (d) in FIG. 8 and the condition indicated by the arrow (d) in FIG. 9.

Hereinafter, it is assumed that the delay time from A to Z (input→output) in each of the buffers BUF 31 and 32a to 32j is 1.0 ns, the delay time in all the wirings is 0.5 ns, and the delay time from C to Q (clock input terminal→output terminal) in the DFF 33a is 2.0 ns under, for example, the MIN condition. Further, the hold time defined as a specification value for the DFF 33b is 0.5 ns. The above delay time is calculated in view of the wiring length and the wiring type, the load of each device, and the waveform distortion of input signal.

FIG. 11 is a diagram explaining an example calculation for the delay time in the data path.

The data path has a pathway of input terminal CK→BUF 31→BUF 32f→BUF 32g→BUF 32h→BUF 32i→BUF 32j→DFF 33a→DFF 33b. Therefore, the propagation delay time (MIN condition) in the data path is the sum of the device propagation delay time and the wiring propagation delay time (=12.0 ns).

FIG. 12 is a diagram explaining an example calculation of the delay time in the clock path of when the in-chip variations are not taken into consideration.

The clock path has a pathway of input terminal CK→BUF 31→BUF 32a→BUF 32b→BUF 32c→BUF 32d→BUF 32e→DFF 33b. Therefore, the propagation delay time (MIN condition) in the clock path of when the in-chip variations are not taken into consideration is the sum of the device propagation delay time and the wiring propagation delay time (=9.5 ns).

FIG. 13 is a diagram explaining an example of calculation of the delay time in the clock path when the in-chip variations are taken into consideration (under conditions shown with arrow (d) in FIG. 8 and FIG. 9).

Conventionally, the delay time of when the in-chip variations are taken into consideration is calculated by calculating a variation coefficient under each condition, and multiplying the variation coefficient of the device propagation delay time and the wiring propagation delay time in which there is a need to consider the in-chip variations.

The variation coefficient is defined as follows:

variation coefficient={(maximum value that delay time may vary when the in-chip variations are taken into consideration)/(delay time when the in-chip variations are not taken into consideration)} (Equation 5)

In other words, the variation coefficient of the device propagation delay time under the MIN condition is {(0.7/0.5=1.4)} from FIG. 8.

The variation coefficient of the wiring propagation delay time under the MIN condition is {(0.7/0.5=1.4)} from FIG. 9.

The propagation delay time (MIN condition) in the clock path of when the in-chip variations are taken into consideration is the sum of the device propagation delay time and the wiring propagation delay time (=12.7 ns).

FIG. 14 is a timing chart showing the result of each of the above delay time calculations.

As shown in FIG. 14, when the in-chip variations are not taken into consideration, it can be verified that the hold time in the DFF 33b is 12.0(ns)−9.5(ns)=2.5(ns) and has a margin of 2.0 ns with respect to the specification value 0.5 ns defined for the DFF 33b.

When the in-chip variations are taken into consideration, it is checked that the hold time in the DFF 33b is 12.0(ns)−12.7(ns)=−0.7(ns) and lacks 1.2 ns with respect to the specification value 0.5 ns defined for the DFF 33b.

Suitability is more strictly checked in the timing check in which the in-chip variations are considered than when the in-chip variations are not considered. Conventionally, the set-up time check and the hold time check under each condition are performed based on the delay time calculated in consideration of the in-chip variations (variation coefficient). Thus, by changing the wiring layout and the logic circuit based on the verification result, a stable yield is obtained during LSI fabrication.

From the calculation results obtained above, the variation in the propagation delay time in the clock path between when the in-chip variations are taken into consideration and when the in-chip variations are not taken into consideration is 12.7(ns)−9.5(ns)=3.2(ns). The variation in the delay time corresponds to the sum of the propagation delay time (device propagation delay time+wiring propagation delay time) caused by the in-chip variations of BUFs 32a to 32e (or five buffer stages).

FIG. 15 is a diagram showing a probability distribution (shown with cumulative relative frequency) of the propagation delay time of one buffer stage under the MIN condition.

As shown in FIG. 15, the propagation delay time of one buffer stage caused by the in-chip variations are most likely to be approximately 0.6 ns. The propagation delay time varies within a range of approximately 0.5 ns to approximately 0.7 ns, and using an intermediate value of approximately 0.6 ns, the occurrence probability of when the delay time becomes longer than the intermediate value or when the delay time becomes shorter than the intermediate value gradually becomes lower.

FIG. 16 is a diagram showing the probability density distribution of the propagation delay time of one buffer stage under the MIN condition. The probability density distribution is shown as a normal distribution. The probability density function f(x) is expressed as:

$$f ( x ) = \frac{1}{\sqrt{2 {πσ}^{2}}} exp \{ - \frac{( x - μ )}{2 {σ}^{2}} \} \qquad ( Equation 6 )$$

in which,

μ=0.6(ns); and

σ=0.0333(ns).

Here, using, for example, the variation coefficient (=1.4) of the wiring propagation delay time, the probability of the wiring propagation delay time of one buffer stage being greater than or equal to 0.5(ns)×1.4=0.7(ns) is:

$$\begin{matrix}1 - F ( x ) = 1 - {\int }_{0.7}^{∞} f ( x ) ⅆ x \\ = 1 - {\int }_{0.7}^{∞} \frac{1}{\sqrt{2 {πσ}^{2}}} exp \{ - \frac{( x - μ )}{2 {σ}^{2}} \} \\ \approx 0.27 ( \% )\end{matrix} \qquad ( Equation 7 )$$

Thus, the occurrence probability (approximately 0.27%; refer to Equation 7) of the wiring propagation delay time of one buffer stage being greater than or equal to 0.7 ns is substantially equal to the occurrence probability (calculation omitted) of the delay time (approximately 0.7 ns) corresponding to approximately μ+3σ in the probability density distribution shown in FIG. 16. This means that the delay time of one buffer stage is calculated to be in a suitable occurrence probability within the interval [μ−3σ,μ+3σ] (or 3σ (sigma) range). In other words, in one buffer stage, the timing check that takes into consideration the in-chip variations are efficiently carried out.

If the propagation delay times of the BUFs 32a to 32e are each shown in an independent probability distribution, the probability density distribution thereof will be similarly shown with the normal distribution (refer to FIG. 16). That is, the probability density function for the propagation delay time in each of the BUFs 32a to 32e is expressed by Equation 6.

Therefore, the probability P2 for the wiring propagation delay time of BUFs 32a to 32e all being greater than or equal to 0.7 is, based on the calculation result of Equation 7,

P2=(0.0027)⁵≅1.43E⁻¹¹ (%)

This suggests that the probability for the delay time of BUFs 32a to 32e (five buffer stages) all being greater than or equal to 0.7 ns is extremely low. In other words, the probability of the delay caused by the in-chip variations all being maximum in five buffer stages is extremely low.

Therefore, if, for example, there are ten buffer stages in the clock path, the probability P3 of the wiring propagation delay time of the ten buffer stages all being greater than or equal to 0.7 is P3=(0.0027)¹⁰≅=2.06E⁻²⁴(%) and is thus lower.

### SUMMARY OF THE INVENTION

One aspect of the present invention is a delay time calculating method for calculating delay time for a signal path having cell stages or gate stages in a semiconductor integrated circuit taking into consideration variations in a chip. The method includes extracting the number of cell stages or gate stages in the signal path from a circuit information, and correcting the delay time for the signal path caused by the variations in the chip in accordance with the number of cell stages or gate stages in the signal path.

Another aspect of the present invention is a delay time calculation method for calculating delay time for a signal path in a semiconductor integrated circuit taking into consideration variations in a chip. The method includes extracting wiring length of the signal path, and correcting wiring propagation delay time for the signal path caused by the variations in the chip in accordance with the wiring length of the signal path.

A further aspect of the present invention is a delay time calculation system for executing a delay time calculation process for a signal path having cell stages or gate stages in a semiconductor integrated circuit taking into consideration variations in a chip. The delay time calculation system includes means for correcting the delay time for the signal path caused by the variations in the chip in accordance with the number of cell stages gate stages of the signal path.

A further aspect of the present invention is a delay time calculation system for executing a delay time calculation process for a signal path in a semiconductor integrated circuit taking into consideration variations in a chip. The delay time calculation system includes means for correcting wiring propagation delay time of the signal path caused by the variations in the chip in accordance with wiring length of the signal path.

Other aspects and advantages of the present invention will become apparent from the following description, taken in conjunction with the accompanying drawings, illustrating by way of example the principles of the invention.

### BRIEF DESCRIPTION OF THE DRAWINGS

The invention, together with objects and advantages thereof, may best be understood by reference to the following description of the presently preferred embodiment together with the accompanying drawings in which:

FIG. 1 is a flowchart showing a delay time calculation process according to a first embodiment of the present invention;

FIG. 2 is a schematic diagram of a delay time calculator;

FIG. 3 is a diagram showing a correction function in the first embodiment;

FIG. 4 is a diagram explaining an example of a delay time calculation in a clock path;

FIG. 5 is a diagram showing a correction function according to a second embodiment of the present invention;

FIG. 6 is a diagram showing a correction function according to a third embodiment of the present invention;

FIG. 7 is a diagram showing a propagation delay time under each condition;

FIG. 8 is a diagram showing a device propagation delay time taking into consideration in-chip variations;

FIG. 9 is a diagram showing a wiring propagation delay time taking into consideration the in-chip variations;

FIG. 10 is a detailed diagram of a circuit for carrying out the delay time calculation;

FIG. 11 is a diagram explaining an example of delay time calculation in a data path;

FIG. 12 is a diagram explaining an example of delay time calculation in the clock path;

FIG. 13 is a diagram explaining an example of the delay time calculation in the clock path taking into consideration a variation coefficient in the prior art;

FIG. 14 is a timing chart showing the results of each delay time calculation;

FIG. 15 is a diagram showing a probability distribution of the propagation delay time under the MIN condition; and

FIG. 16 is a diagram showing a probability density of the propagation delay time under the MIN condition.

### DETAILED DESCRIPTION OF THE PREFERRED EMBODIMENTS

Conventionally, if the timing check is carried out in consideration of the in-chip variations, the check is made in all cases including the case in which the occurrence probability of the calculated delay time is extremely low, and the layout and the circuit are corrected based on the timing check result thereof. Thus, the design has an excess timing margin, causing increase in cost and longer layout period. The miniaturization of LSIs has increased the number of flip-flops as well as the number of clock nets installed in one chip. Furthermore, the number of buffer stages within a clock tree has increased. Therefore, if a delay time that is unlikely to occur is checked, timing close cannot be performed in the designing stage (set-time and hold time cannot be guaranteed).

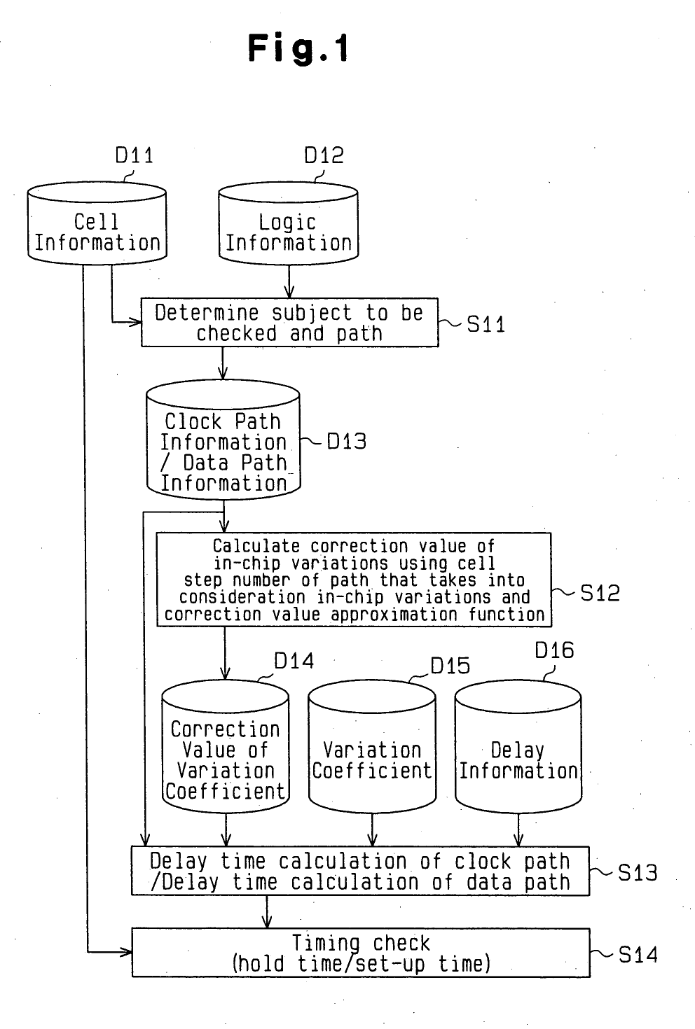

A delay time calculation method and a delay time calculation system for a semiconductor integrated circuit according to a first embodiment of the present invention will now be explained with reference to FIGS. 1 to 4. The present embodiment explains one example for carrying out the timing check of the set-up time and the hold time in the semiconductor integrated circuit (LSI), and uses the circuit 30 shown in FIG. 10 as the circuit used for the timing check.

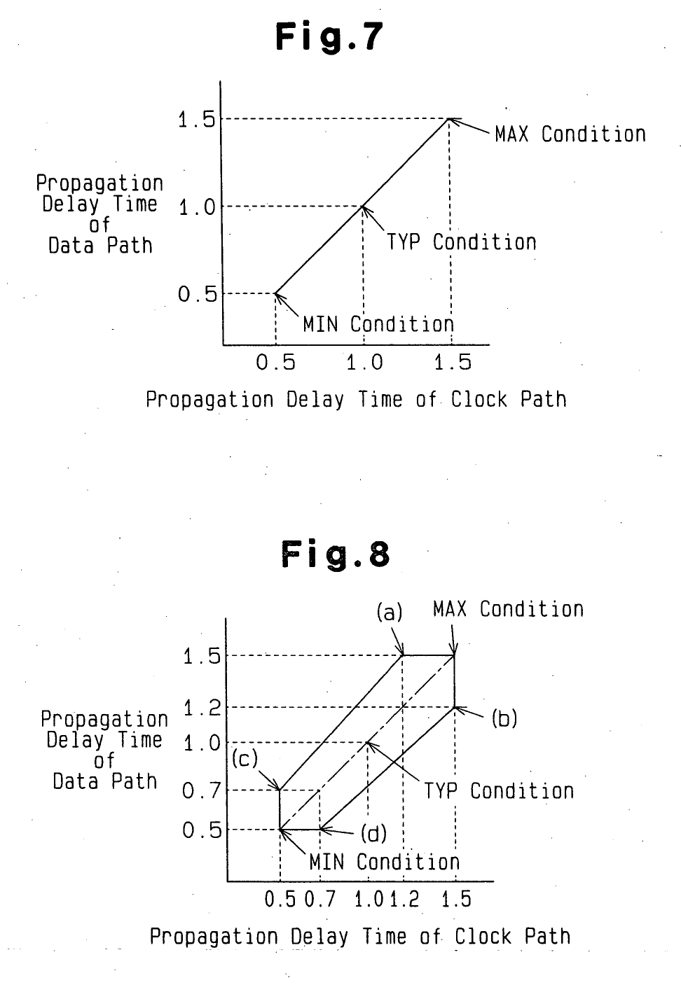

The timing check is carried out using for example, a static timing analysis tool and the like, and is carried out under the condition that when the propagation delay time of the signal path, on which checking is performed, is the maximum (MAX condition), typical (TYP condition), or minimum (MIN condition). Each condition of the MAX condition, the TYP condition, and the MIN condition is determined in accordance with the process characteristic, the power supply voltage, the junction temperature involved in the change in ambient temperature, and the like (refer to FIG. 7).

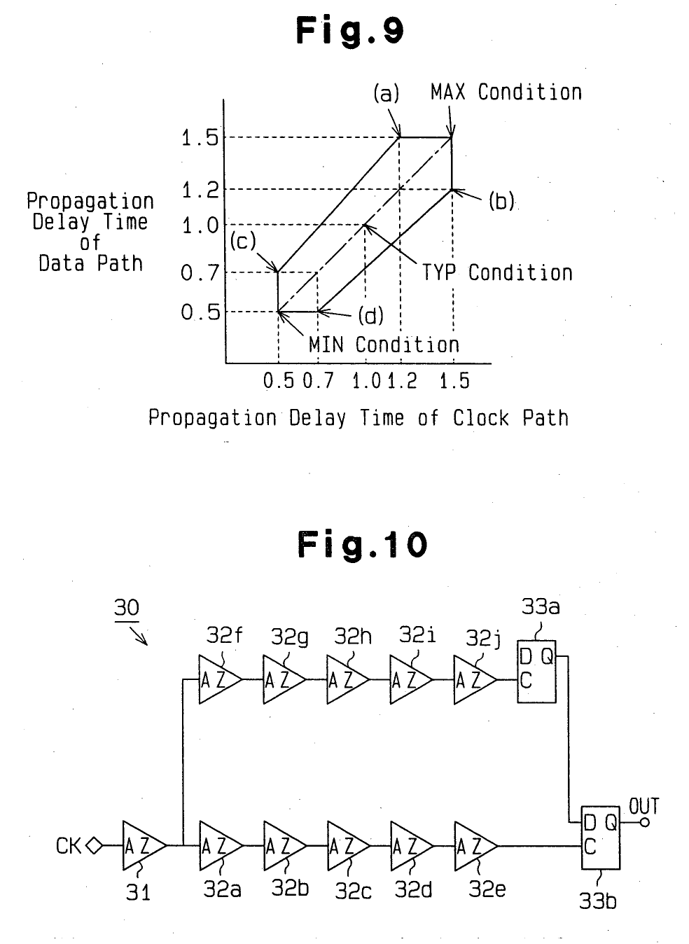

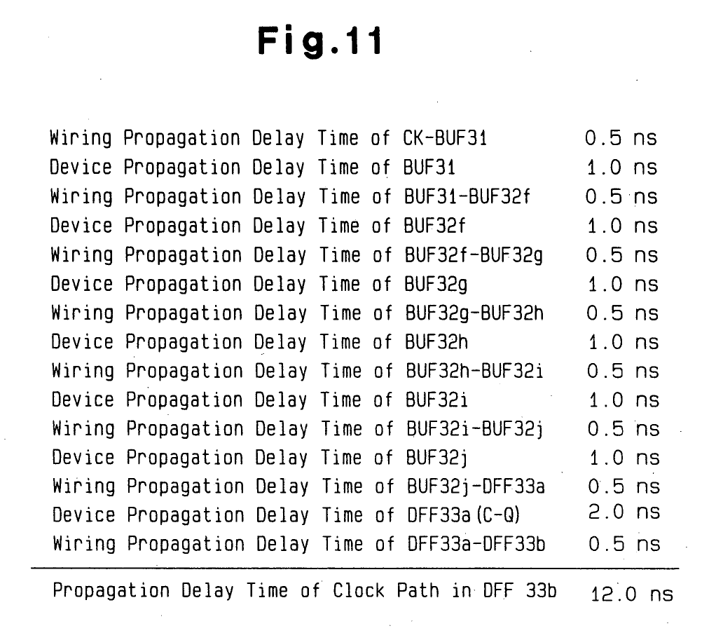

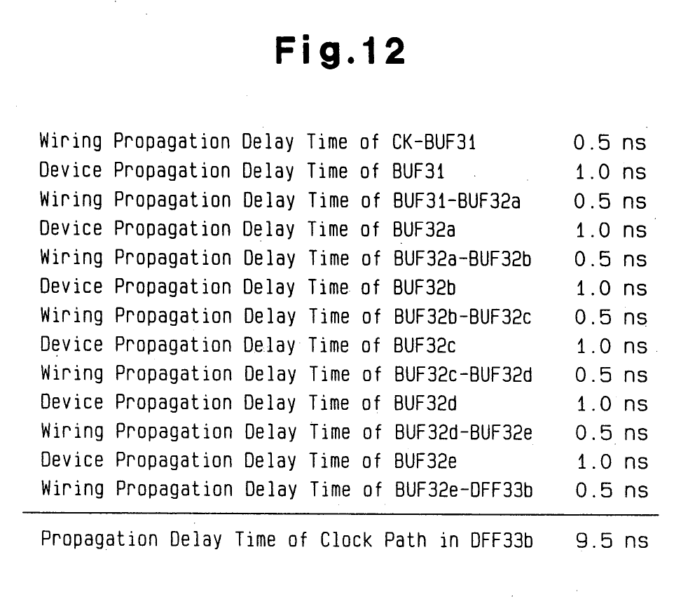

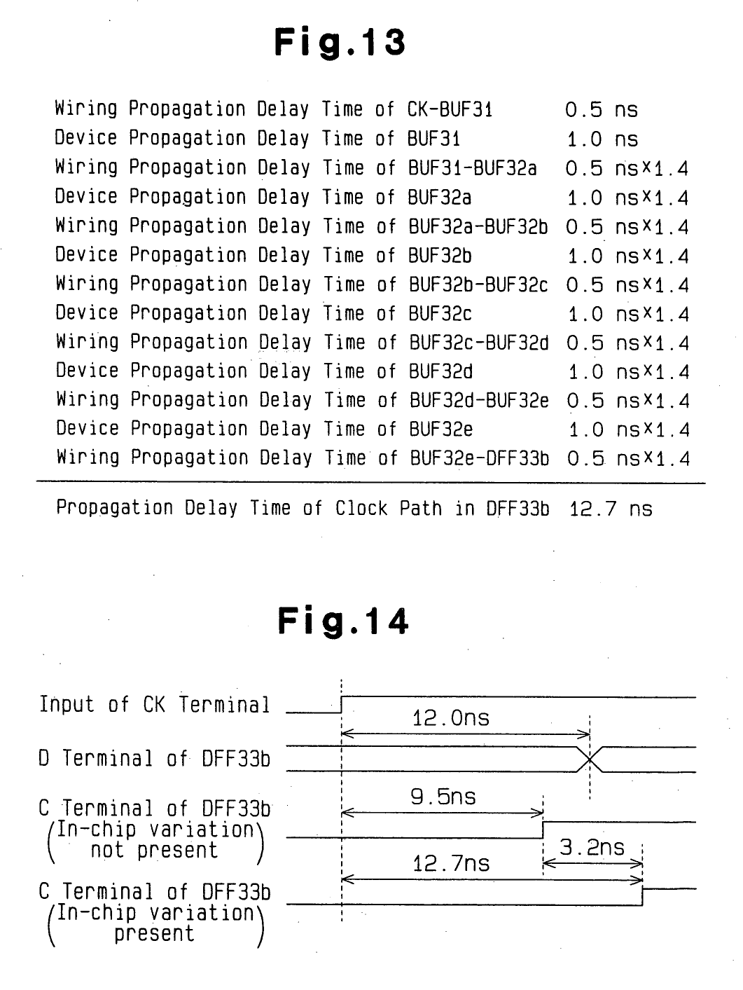

The propagation delay time of the signal path under each of the above conditions also varies with the in-chip variations of the LSI (refer to FIG. 8 and FIG. 9). The in-chip variations includes, for example, the process characteristic variation due to variation of wiring resistance, variation of contact resistance, variation of transistor property and the like. Further in-chip variations include the power supply voltage variation due to power supply voltage drop within the chip and the temperature variation within the chip due to non-uniform device arrays and operating frequencies within the chip.

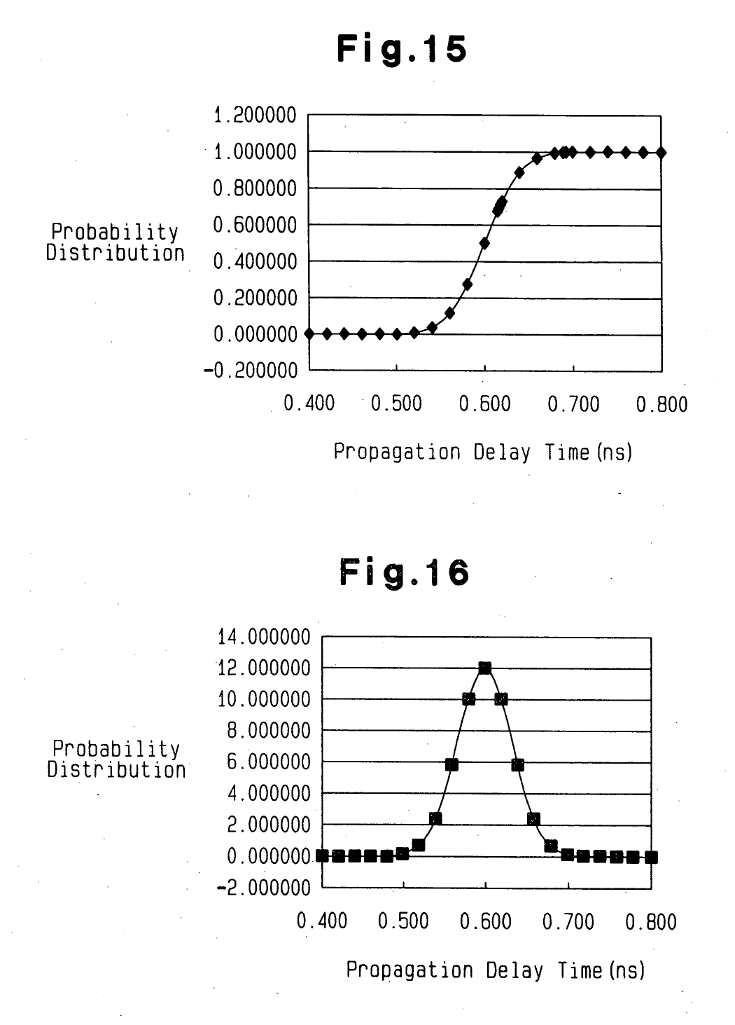

The propagation delay time of the signal path caused by the in-chip variations are shown with a probability distribution (refer to FIG. 15) in which the propagation delay time substantially varies within a range of a predetermined delay time, and the probability density distribution thereof is shown with a normal distribution (refer to FIG. 16).

In the present embodiment, the propagation delay time of the signal path is calculated in consideration of the in-chip variations under one of the conditions of the above mentioned MAX condition, the TYP condition and the MIN condition, as well as the probability distribution of the propagation delay time caused by the in-chip variations.

The propagation delay time Ts of the signal path is calculated from the following equation:

Ts=Tx{1+(α−1)×β} (Equation 1)

in which,

Ts: propagation delay time in consideration of the in-chip variations and the probability distribution;

T: propagation delay time under each condition;

α: variation coefficient;

β: correction value for the variation coefficient.

The variation coefficient α is a value showing the variation degree of the device propagation delay time and the wiring propagation delay time in the signal path, and is calculated for each of the conditions of the MAX condition, the TYP condition, and the MIN condition. The variation coefficient α is calculated from the previously mentioned relational expression (refer to Equation 5).

The correction value β is calculated, in accordance with the gate stage number and the cell stage number of the signal path, based on a function (correction function for the variation coefficient α) that approximates the propagation delay time due to the in-chip variations for the actual propagation delay time influenced by the in-chip variations. That is, by correcting the variation coefficient α with the correction value β, the propagation delay time Ts is calculated so as to have a suitable occurrence probability (or a value within a range of 3σ (sigma) in the probability density distribution of the propagation delay time shown with the normal distribution). In other words, the propagation delay time having an extremely low occurrence probability is not calculated.

As the correction function for the variation coefficient α, the approximation function for the correction value β is, for example, expressed as:

β=a⁽ⁿ⁻¹⁾ (Equation 2)

in which

a: base of the correction function; and

n: cell stage number (or gate stage number) of the signal path.

The base a of the correction function is a value set in accordance with the cell stage number n of the signal path. In the present embodiment, the base a of the correction function is set so that the occurrence probability of the propagation delay time Ts calculated in accordance with the variation coefficient α, which is corrected with the correction value β, is the occurrence probability of the delay time corresponding to approximately μ+3σ (sigma) in the probability density distribution.

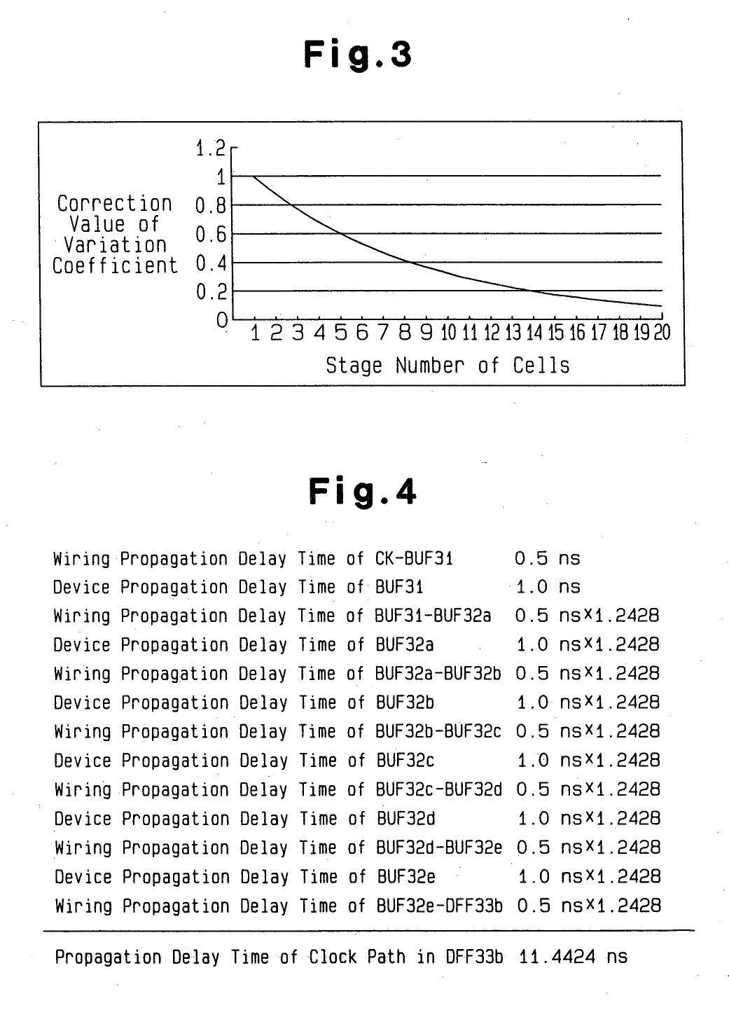

FIG. 3 is a diagram showing the correction function (Equation 2) of, for example, when a=0.8827.

As shown in the drawing, the correction value β of the variation coefficient α decreases as the cell stage number n of the signal path increases. More specifically, when the value of the cell stage number n is “1” (one stage), the value of the correction value β is “1”, and the variation coefficient α is not corrected. When the cell stage number n is n>1, the correction value β is β<1, and the variation coefficient α is corrected with the correction value β so as to be smaller.

FIG. 1 is a flowchart explaining the delay time calculation process of when the timing check (hold time check/set-up time check) is performed.

First, the circuit that is to be checked and the signal path (data path/clock path) on which the delay time calculation is to be performed are determined based on the cell information D11, which includes terminal information for a cell and timing information, and the logic information D12, which includes circuit information (step S11). The cell stage number information of the data path/clock path on which the delay time calculation is performed is extracted from the logic information D12 and data path information/clock path information (hereinafter referred to as path information) D13 is generated.

Next, in accordance with the path information D13 and the above mentioned approximation function (Equation 2) of the correction value, the correction value β (D14) of the variation coefficient α is calculated for the signal path that takes the in-chip variations into consideration (step S12).

The delay times of the data path and the clock path are calculated based on the correction value β (D14) of the variation coefficient α calculated in step S12, the variation coefficient α (D15), and the delay information D16 (step S13).

The variation coefficient α (D15) is determined in accordance with the process characteristic, the power supply voltage, the temperature and the like that are the factors causing the in-chip variations mentioned above from actual measurements by means of a SPICE simulation or a property test element group (TEG). Further, a resistance value and a capacity value in the signal path extracted from layout information, and the cell delay time and the wiring delay time calculated based on the process characteristic, the power supply voltage, the temperature and the like are included in the delay information D16.

The timing check (hold time check/set-up time check) is performed based on the delay times of the data path and the clock path calculated in step S13 (step S14). When performing the timing check, the specification value of the hold time or the set-up time of the circuit that is checked is extracted from the cell information D11, and the timing check is performed based on the specification value.

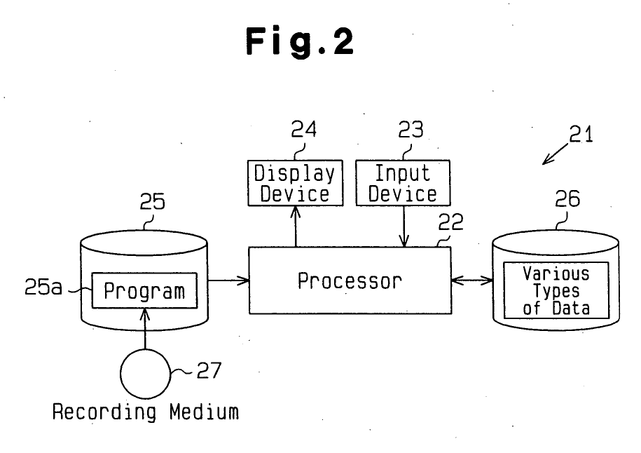

FIG. 2 is a schematic diagram of a delay time calculator (hereinafter referred to as a “calculator”) 21. The calculator 21 is configured by connecting an input device 23, a display device 24, and storage devices 25 and 26 to a processor 22.

The input device includes a keyboard and a mouse (not shown), and is used to, for example, start a program, and to input user requests, user commands, or parameters. The display device 24 includes an output device, such as a monitor (e.g., a CRT, an LCD, or a PDP) or a printer (not shown), and is used to display the process result of the delay calculation and a parameter input screen.

The storage devices 25 and 26 normally include a magnetic disk device, an optical disc device, and a magneto-optic disc device, which are appropriately used in accordance with the type and state of the data stored in the storage devices 25 and 26. FIG. 2 shows the storage devices 25 and 26 in a functionally divided state. However, the storage devices 25 and 26 may also be in a non-divided state. Alternatively, data may be divided and stored in a plurality of storage devices.

The first storage device 25 stores program data 25a for executing the delay time calculation process. The program data 25a is provided from a recording medium 27. The processor 22 drives a driving device (not shown) in response to a command from the input device 23, loads the program data 25a recorded on the recording medium 27 to the first storage device 25, and sequentially executes the program data. The processor 22 performs the delay time calculation process. The processor 22 may be configured so as to directly execute the program data 25a recorded on the recording medium 27.

The recording medium 27 may be a memory card, a flexible disk, an optical disc (CD-ROM, DVD-ROM, or the like), a magneto-optic disk (MO, MD, or the like) (not shown), or any computer-readable recording medium. The recording medium 27 may also be a medium recording the program data 25a that is uploaded or downloaded via a communication medium or a disk device. Alternatively, the recording medium 27 may be a recording medium recording the program data 25a that is directly executable by the processor 22.

The second storage device 26 is used as a database for storing various types of data to execute the delay time calculation process, and stores the above mentioned cell information D11 and the logic information D12, as well as the path information D13 extracted or calculated in the executed process, the variation coefficient α (D15), the correction value β (D14), and the delay information D16.

A case in which the hold time check of the DFF 33b is performed under, for example, the MIN condition using the circuit 30 shown in FIG. 10 will now be explained. The delay time from A to Z (input→output) in each of the buffers BUF 31, and 32a to 32j is 1.0 ns, the delay time in all of the wirings is 0.5 ns, and the delay time from C to Q (clock input terminal→output terminal) in the DFF 33a is 2.0 ns under the MIN condition. Further, the hold time defined as a specification value for the DFF 33b is 0.5 ns.

When performing the hold time check under the MIN condition, the propagation delay times of the data path and the clock path are calculated under the condition indicated by arrow (d) in FIG. 8 and the condition indicated by arrow (d) in FIG. 9.

In other words, the propagation delay time of the data path is calculated for a case in which there is no influence of the in-chip variations under the MIN condition and is the sum (12.0 ns) of the device propagation delay time and the wiring propagation delay time.

The propagation delay time of the clock path is calculated for a case in which there is influence of the in-chip variations under the MIN condition. Accordingly, each variation coefficient α of the device propagation delay time and the wiring propagation delay time is 1.4 from FIG. 8, FIG. 9, and Equation 5.

With respect to the correction function of the variation coefficient α shown in Equation 2, the value of the base a of the correction function is set to, for example, 0.8827 in accordance with the BUFs 32a to 32e (five buffer stages (n=5)) of the clock path. Thus, the correction value β is 0.6071 (≅0.8827⁽⁵⁻¹⁾.

Therefore, the propagation delay time Ts of the clock path (Equation 1) using the correction value β of the variation coefficient α is,

Ts=T×{1+(1.4−1)×0.6071}≈T×1.2428 (Equation 1a)

FIG. 4 is a diagram explaining an example calculation of the propagation delay time of the clock path based on Equation 1a. The calculation of the delay time in the pathway shared by the data path and the clock path, or the wiring propagation delay time from the input terminal CK to the BUF 31, and the calculation of the device propagation delay time of the BUF 31 do not take into consideration influences of the in-chip variations. Therefore, the propagation delay time of the clock path is the sum (11.4424 ns) of the device propagation delay time and the wiring propagation delay time.

Accordingly, the hold time of the DFF 31b under the MIN condition becomes 12.0(ns)−11.4424(ns)=0.5576(ns). It is thus checked that there is a margin of 0.0576 ns with respect to the specification value 0.5 ns defined for the DFF 33b.

The probability of the wiring propagation delay time of one buffer stage caused by the in-chip variations under the MIN condition being greater than or equal to 0.5(ns)×1.2428=0.6214(ns), calculated in accordance with the probability density function (Equation 6), is about 30.5%.

Therefore, the probability P1 that five buffer stages (BUF 32a to 32e) in the clock path all being greater than or equal to 0.6214 ns is,

P1=(0.305)⁵≅0.00264=0.264(%)

In other words, the occurrence probability that wiring propagation delay time of five buffer stages is greater than or equal to 0.6214 ns is substantially equal to the occurrence probability (calculation omitted) of the delay time (approximately 0.7 ns) corresponding to approximately μ+3σ in the probability density distribution (refer to FIG. 16). This means that the delay time of five buffer stages is calculated with an appropriate occurrence probability in the interval [μ−3σ,μ+3σ](3σ range).

The delay time calculation method and the delay time calculation system of the semiconductor integrated circuit according to the first embodiment of the present invention have the following features.

(1) The propagation delay time Ts of the signal path taking into consideration the in-chip variations are calculated based on the variation coefficient α corrected with the correction value β. The correction value β is, in accordance with the cell stage number n of the signal path, calculated with a function that approximates the propagation delay time caused by the in-chip variations to the actual propagation delay time influenced by the in-chip variations. Thus, the propagation delay time Ts is calculated so as to have the appropriate occurrence probability within a 3σ(sigma) range in the probability density distribution shown with the normal distribution. In other words, the propagation delay time having an extremely low occurrence probability is not calculated. Therefore, the timing check is efficiently carried out, and LSI designing is performed at an appropriate manufacturing cost (gate number and development man power).

(2) In the present embodiment, the correction value β is set so that the occurrence probability of the calculated propagation delay time Ts is the occurrence probability of the propagation delay time corresponding to approximately μ+3σ (sigma). By setting the correction value β in this manner, a high-quality (highly reliable) timing check is performed to achieve LSI designing having a suitable manufacturing margin.

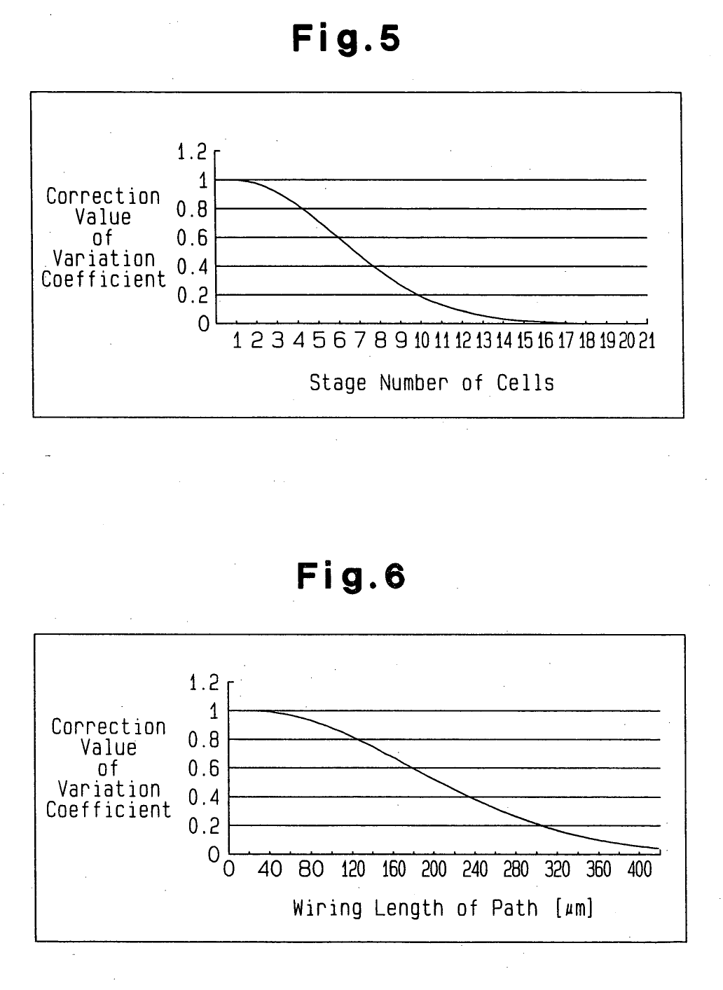

A delay time calculation method and the delay time calculation system of a semiconductor integrated circuit according to a second embodiment of the present invention will now be explained with reference to FIG. 5.

The present embodiment explains an example of another approximation function of the correction value β used as the correction function (refer to Equation 2) of the variation coefficient α explained in the first embodiment.

The approximation function of the correction value β in the present embodiment is expressed as:

β=e^{-kn2} (Equation 3)

in which,

e: natural constant;

k: k>0;

n: cell stage number of signal path.

The value of the coefficient k is set in accordance with the cell stage number n of the signal path in the same manner as the first embodiment.

FIG. 5 is a diagram showing the correction function (Equation 3) of when, for example, k=0.02, and the correction value β of the variation coefficient a decreases as the cell stage number n of the signal path increases in the same manner as the first embodiment. Therefore, the present embodiment has the same advantages as the first embodiment.

A delay time calculation method and the delay time calculation system of the semiconductor integrated circuit according to a third embodiment of the present invention will now be explained with reference to FIG. 6.

The present embodiment explains an example of another approximation function of the correction value β as the correction function (refer to Equation 2) of the variation coefficient α explained in the first embodiment.

The approximation function of the correction value β of the present embodiment is expressed as:

β=e^{-k12} (Equation 4)

in which

e: natural constant;

k: k>0;

n: wiring length of signal path.

The wiring length l is the total length of all the wiring in the signal path and the value of the coefficient k is set in accordance with the wiring length l.

In the present embodiment, when calculating the wiring propagation delay time of the signal path on which the timing check is performed, the correction value P of the variation coefficient α is calculated based on the correction function expressed by Equation 4. More specifically, when calculating the device propagation delay time, the correction value β is calculated with the correction function (Equation 2 or Equation 3) in which the correction value β is approximated in accordance with the cell stage number n. When calculating the wiring propagation delay time, the correction value β is calculated with the correction function (Equation 4) in which the correction value β is approximated in accordance with the wiring length l.

FIG. 6 is a diagram showing the correction function (Equation 4) of when, for example, k=0.000002, and the correction value β of the variation coefficient α also decreases as the wiring length l of the signal path increases.

The delay time calculation method and the delay time calculation system of the semiconductor integrated circuit according to the third embodiment of the present invention has the following features.

(1) In the present embodiment, the wiring propagation delay time of the signal path is corrected based on the correction value β calculated in accordance with the wiring length l of the relevant signal path. The device propagation delay time and the wiring propagation delay time are thus corrected with a different correction value β. This improves the quality of the timing check.

It should be apparent to those skilled in the art that the present invention may be embodied in many other specific forms without departing from the spirit or scope of the invention. Particularly, it should be understood that the present invention may be embodied in the following forms.

The approximation function of the correction value β provided as the correction function of the variation coefficient α is not limited to each of the above embodiments and may also correspond to other approximation functions.

The value of the base a of the correction function shown in Equation 2 is not limited to the value (0.8827) explained in the first embodiment and may also be other values as long as the delay time of the signal path is approximated as the actual delay time influenced by the in-chip variations.

Similarly, the values of the coefficient k in Equation 3 and Equation 4 are not limited to the values explained in the second and the third embodiment, respectively, and may also be other values.

It should be apparent to those skilled in the art that the present invention may be embodied in many other specific forms without departing from the spirit or scope of the invention. Therefore, the present invention is not to be limited to the details given herein, but may be modified within the scope and equivalence of the appended claims.

What is claimed is:

1. A delay time calculating method for calculating delay time for a signal path having cell stages or gate stages in a semiconductor integrated circuit taking into consideration variations in a chip, the method comprising:
extracting the number of cell stages or gate stages in the signal path from a circuit information; and
correcting the delay time for the signal path caused by the variations in the chip in accordance with the number of cell stages or gate stages in the signal path.

2. The delay time calculation method as claimed in claim 1, wherein said correcting is performed on device propagation delay time for the signal path.

3. The delay time calculation method as claimed in claim 1, wherein said correcting is performed on wiring propagation delay time for the signal path.

4. The delay time calculation method as claimed in claim 1, further comprising:
calculating a variation coefficient for the delay time that changes due to the variations in the chip; and
calculating a correction value for the variation coefficient with a correction function approximated in accordance with the number of cell stages or gate stages of the signal path.

5. A delay time calculation method for calculating delay time for a signal path in a semiconductor integrated circuit taking into consideration variations in a chip, the method comprising:
extracting wiring length of the signal path; and
correcting wiring propagation delay time for the signal path caused by the variations in the chip in accordance with the wiring length of the signal path.

6. The delay time calculation method as claimed in claim 5, wherein the signal path includes cell stages or gate stages, and device propagation delay time of the signal path is corrected in accordance with the number of cell stages or gate stages in the signal path.

7. The delay time calculation method as claimed in claim 5, further comprising:
calculating a variation coefficient for delay time that changes due to variations in the chip; and
calculating a correction value for the variation coefficient with a correction function approximated in accordance with the wiring length of the signal path.

8. The delay time calculation method as claimed in claim 5, wherein the delay time caused by the variations in the chip has a probability density distribution represented by a normal distribution, the method further comprising:
correcting the delay time so that the delay time has an occurrence probability corresponding to an approximately 3σ range in the probability density distribution.

9. The delay time calculation method as claimed in claim 8, further comprising:
correcting the delay time so that the delay time has an occurrence probability of approximately (μ+3σ) in the probability density distribution.

10. The delay time calculation method as claimed in claim 6, further comprising:
calculating a variation coefficient for the delay time that changes due to the variations in the chip; and
calculating a correction value for the variation coefficient with a correction function approximated in accordance with the number of cell stages or gate stages of the signal path.

11. A delay time calculation system for executing a delay time calculation process for a signal path having cell stages or gate stages in a semiconductor integrated circuit taking into consideration variations in a chip, the delay time calculation system comprising:
means for correcting the delay time for the signal path caused by the variations in the chip in accordance with the number of cell stages gate stages of the signal path.

12. The delay time calculation system of claim 11, further comprising:
a delay time calculator having a processor and data storage storing program instructions which when executed by the processor calculate the delay time for the signal path.

13. The delay time calculation system of claim 11, wherein the means for correcting is applied to device propagation delay time for the signal path.

14. The delay time calculation system of claim 11, wherein the means for correcting is applied to wiring propagation delay time for the signal path.

15. The delay time calculation system of claim 14, wherein the means for correcting is also for calculating a variation coefficient for delay time that changes due to variations in the chip.

16. A delay time calculation system for executing a delay time calculation process for a signal path in a semiconductor integrated circuit taking into consideration variations in a chip, the delay time calculation system comprising:
means for correcting wiring propagation delay time of the signal path caused by the variations in the chip in accordance with wiring length of the signal path; and

17. The delay time calculation system of claim 16, further comprising a delay time calculator having a processor and data storage storing program instructions which when executed by the processor calculate the delay time for the signal path.

18. The delay time calculation system of claim 16, wherein the signal path includes gate or cell stages, further comprising means for correcting device propagation delay time caused by the variations in the chip in accordance with the number of cell or gate stages in the signal path.

19. The delay time calculation system of claim 16, wherein the means for correcting wiring propagation delay time also performs correction of the delay time caused by the variations in the chip in accordance with the number of cell or gate stages in the signal path.

20. The delay time calculation system of claim 16, wherein the means for correcting is also for calculating a variation coefficient for delay time that changes due to variations in the chip.
